(19) United States
(12) Patent Application Publication
(10) Pub. No.: US 2025/0186964 A1
(43) Pub. Date: Jun. 12, 2025

(54) APPARATUS AND METHOD FOR PRODUCING CATALYST PARTICLES

(71) Applicant: CANATU OY, Vantaa (FI)

(72) Inventors: Taneli Juntunen, Helsinki (FI); Olivier Reynaud, Veikkola (FI); Takumi Okamoto, Suzuka-city (JP); Keisuke Fugane, Nagoya-city (JP)

(73) Assignee: CANATU OY, Vantaa (FI)

(21) Appl. No.: 18/845,815

(22) PCT Filed: Mar. 24, 2023
(86) PCT No.: PCT/FI2023/050166

§ 371 Date: Sep. 10, 2024

(30) Foreign Application Priority Data
Mar. 24, 2022 (FI) 20225259

(51) Int. Cl. B01J 19/26; B01J 4/00; B01J 19/00; B01J 19/24; B01J 21/18; B01J 37/08; C01B 32/159; C01B 32/16

(52) U.S. Cl. CPC B01J 19/26; B01J 4/002; B01J 19/0013; B01J 19/2415; B01J 21/185; B01J 37/084; C01B 32/159; C01B 32/16; B01J 2204/002; B01J 2204/007; B01J 2219/00063; B01J 2219/00166; C01B 2202/02; C01B 2202/06

(57) ABSTRACT

This specification relates to an apparatus and a method for producing catalyst particles as well as a high-aspect-ratio molecular structure network. The apparatus comprises a flow reactor and a laminar injector configured to introduce a catalyst particle precursor into the flow reactor. The laminar injector comprises a temperature-controlled flow straightener arranged upstream of the flow reactor.

### FIELD OF TECHNOLOGY

This disclosure concerns production of catalyst particles. Additionally, this disclosure concerns synthesis of carbon-based high-aspect-ratio molecular structures, particularly by floating-catalyst chemical vapor deposition.

### BACKGROUND

Films comprising networks of carbon-based high-aspect-ratio molecular structures (HARMSs), such as carbon nanotubes and carbon nanobuds, may be used in various applications in which films of high electrical conductivity and optical transmittance are required.

Various methods have been developed for synthesizing HARMSs. One of the most promising synthesis methods for industrial-scale production of HARMSs is so-called floating-catalyst chemical vapor deposition (FCCVD) due to its low cost, high throughput, as well as the high degree of control attainable by FCCVD over various structural parameters, e.g., lengths, diameters, and/or functional group densities, of synthesized HARMSs.

In FCCVD, catalyst composition and size are critical process parameters that have a major impact on the morphology and properties of synthesized HARMSs. Although FCCVD synthesis methods have already been utilized to form HARMS films with sheet resistances as low as approximately 100 Ω/sq at more than 95% optical transmittance, improved control of catalyst composition and size could lead to further improvements in the properties of FCCVD-grown HARMS networks.

In light of the above, it may be desirable to develop new solutions related to methods for producing catalyst particles.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to a first aspect, an apparatus for producing catalyst particles is provided. The apparatus comprises a flow reactor and a laminar injector configured to introduce a catalyst particle precursor into the flow reactor. The laminar injector comprises a temperature-controlled flow straightener arranged upstream of the flow reactor.

According to a second aspect, a method for producing catalyst particles is provided. The method comprises introducing a catalyst particle precursor into a flow reactor via a temperature-controlled flow straightener arranged upstream of the flow reactor.

It is specifically to be understood that catalyst particles may generally be produced according to any method in accordance with the second aspect using an apparatus in accordance with the first aspect. Similarly, an apparatus in accordance with the first aspect may be provided with means for producing catalyst particles according to any method in accordance with the second aspect.

In an embodiment, the apparatus for producing catalyst particles and/or the method for producing catalyst particles is implemented as an apparatus for producing high-aspect-ratio molecular structures (HARMS) and/or a method for producing HARMS.

According to a third aspect, a HARMS network is provided. The HARMS network comprises carbon-based HARMSs obtainable by an apparatus and a method in accordance with the preceding embodiment.

It is specifically to be understood that an apparatus for producing HARMS in accordance with the first aspect and/or a method for producing HARMS in accordance with the second aspect may be used to produce a HARMS network in accordance with the third aspect.

### BRIEF DESCRIPTION OF THE DRAWINGS

The present disclosure will be better understood from the following detailed description read in light of the accompanying drawings, wherein:

FIG. 1 shows an apparatus for producing catalyst particles,

FIG. 2 depicts a partial sectional view of the apparatus of FIG. 1,

FIG. 3 illustrates a method for producing catalyst particles, and

FIG. 4 depicts a HARMS network.

Unless specifically stated to the contrary, any drawing of the aforementioned drawings may be not drawn to scale such that any element in said drawing may be drawn with inaccurate proportions with respect to other elements in said drawing in order to emphasize certain structural aspects of the embodiment of said drawing.

Moreover, corresponding elements in the embodiments of any two drawings of the aforementioned drawings may be disproportionate to each other in said two drawings in order to emphasize certain structural aspects of the embodiments of said two drawings.

### DETAILED DESCRIPTION

Concerning apparatuses and methods discussed in this detailed description, the following shall be noted.

Throughout this specification, a “high-aspect-ratio molecular structure” or a “HARMS” may refer to a nanostructure, i.e. a structure with one or more characteristic dimensions in nanoscopic scale, e.g., greater than or equal to 0.1 nanometers (nm) and less than or equal to about 100 nm. Additionally or alternatively, a HARMS may refer to a structure having dimensions in two perpendicular directions with significantly different orders of magnitude. For example, a HARMS may have a length which is tens or hundreds of times higher than its thickness and/or width.

Further, a “carbon-based” HARMS may refer to a HARMS consisting primarily of carbon (C). Additionally, or alternatively, a carbon-based HARMS may refer to a HARMS comprising at least 50 atomic percent (at. %), or at least 60 at. %, or at least 70 at. %, or at least 80 at. %, or at least 90 at. %, or at least 95 at. % of carbon.

Generally, carbon-based HARMSs may be doped with non-carbon dopants, for example, to alter their electrical and/or thermal properties. Examples of carbon-based HARMSs include carbon nanotubes, carbon nanobuds, graphene nanoribbons, and combinations thereof.

In this disclosure, a “high-aspect-ratio molecular structure network” or “HARMS network” may refer to a plurality of mutually interconnected HARMSs. Generally, a HARMS network may form a solid and/or monolithic material at a macroscopic scale, wherein individual HARMSs are non-oriented, i.e., substantially randomly oriented or randomly oriented, or oriented. Typically, a HARMS network may be arranged in various macroscopic forms, for example, as films, which may or may not be optically transparent and/or possess high electrical conductivity.

Herein, a “film” may refer to a structure having its lateral dimensions substantially larger than its thickness. Generally, a film may have any suitable shape, for example, a flat and/or smooth shape or a curved and/or uneven shape.

Throughout this specification, a “catalyst particle” may refer to a particulate piece of matter suitable for increasing the rate of a reaction via catalysis. Additionally or alternatively, a catalyst particle may refer to a particle suitable for heterogenous catalysis. Additionally or alternatively, a catalyst particle may refer to a piece of particulate catalyst material suitable for catalysis of production of carbon-based HARMSs, for example, by chemical vapor deposition, e.g., floating-catalyst chemical vapor deposition (FCCVD).

Generally, a catalyst particle, may comprise, consist substantially of, or consist of one or more transition metals, such as iron (Fe), cobalt (Co), and/or nickel (Ni). Typically, a catalyst particle may have any suitable diameter, for example, a diameter in a range from 0.1 nm to 300 nm, or from 1 nm to 200 nm, or from 5 nm to 100 nm, or from 10 nm to 50 nm.

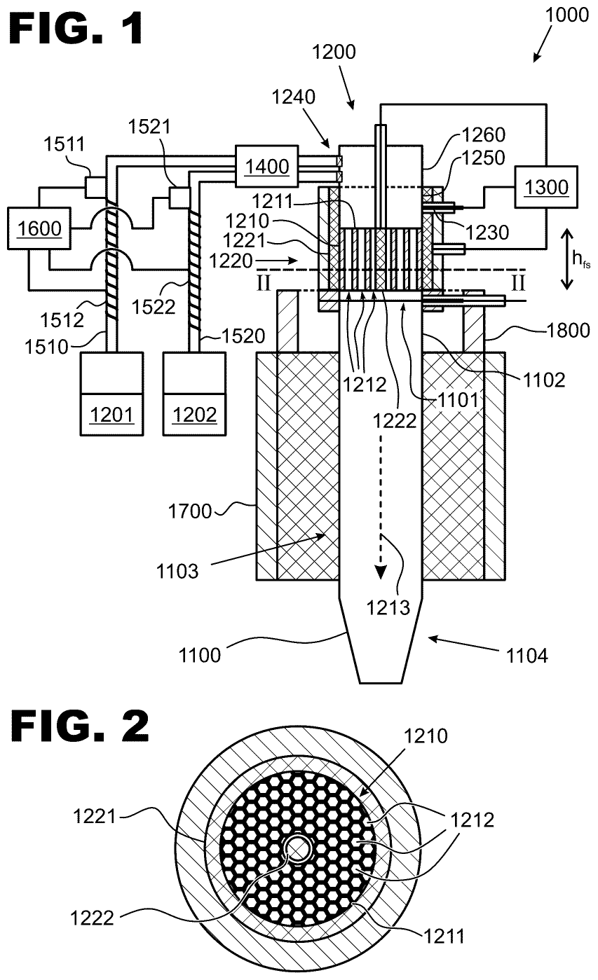

FIG. 1 schematically depicts an apparatus 1000 for producing catalyst particles, and FIG. 2 schematically shows a partial sectional view of the apparatus 1000 along plane II-II shown in FIG. 1.

In the embodiment of FIGS. 1 and 2, the apparatus 1000 comprises a flow reactor 1100.

Herein, a “flow reactor” may refer to a reactor into which one or more catalyst particle precursors and, optionally, one or more reactants, such as a carbon source, and/or one or more auxiliary substances, e.g., catalysts and/or growth promoters, such as sulfur (S); phosphorus (P); nitrogen (N); one or more sulfur-containing compounds, e.g., hydrogen sulfide (H₂S), carbon bisulfide (CS₂), and/or thiophene (C₄H₄S); one or more phosphorus-containing compounds, e.g., phosphane (PH₃); one or more nitrogen-containing compounds, e.g., ammonia (NH₃) and/or nitric oxide (NO); and/or redox agents, e.g., oxygen (O₂), water (H₂O), carbon dioxide (CO₂), and/or hydrogen (H₂), are introduced, for example, continuously introduced, and wherefrom one or more products are collected, for example, continuously collected. Additionally or alternatively, a flow reactor may refer to a reactor through which one or more reactants pass and wherein catalysis is in progress. Typically, a flow reactor may be formed of any suitable material(s), for example, stainless steel, fused silica, or fused quartz.

In the embodiment of FIGS. 1 and 2, the apparatus 1000 further comprises a laminar injector 1200 configured to introduce a catalyst particle precursor 1201 into the flow reactor 1100.

Throughout this disclosure, a “precursor” may refer to a chemical substance from which another chemical substance or other product may be formed. Generally, a precursor may be used in any suitable state of matter, e.g., in solid, gaseous, or liquid form. Naturally, a “catalyst particle precursor” may then refer to a precursor for forming catalyst particles. Additionally or alternatively, a catalyst particle precursor may refer to a precursor comprising, consisting substantially of, or consisting of one or more iron-containing organometallic or metalorganic compounds, such as ferrocene (Fe(C₅H₂)2), iron pentacarbonyl (Fe(CO)₅), and/or iron(II)phthalocyanine (C₃₂H₁₆FeN₈); and/or one or more nickel-containing organometallic or metalorganic compounds, such as nickelocene (Ni(C₅H₅)₂); and/or one or more cobalt-containing organometallic or metalorganic compounds, such as cobaltocene (Co(C₅H₅)₂).

In this specification, a “laminar injector” or “laminar gas distributor” may refer to a device configured to introduce one or more catalyst particle precursors and optionally, one or more reactants and/or one or more further auxiliary substances, e.g., catalysts, into a flow reactor. Additionally or alternatively, a laminar injector may refer to a device suitable for or configured to introduce one or more fluids, such as gases, and/or aerosols into a flow reactor such that a laminar flow profile is maintained at an upstream end of said flow reactor.

Herein, a “laminar flow profile” being maintained at a specific position of a flow reactor may refer to maintaining a Reynolds number (Re) less than or equal to 2300, or less than or equal to 2100, or less than or equal to 2000 at said position.

In the embodiment of FIGS. 1 and 2, the laminar injector 1200 comprises a temperature-controlled flow straightener 1210 arranged upstream of the flow reactor 1100. Generally, a laminar injector comprising a temperature-controlled flow straightener upstream of a flow reactor of an apparatus for producing catalyst particles may provide improved control of both the flow characteristics and temperature of a catalyst particle precursor in said flow reactor, which may, in turn, result in increased control over the nucleation of catalyst nanoparticles in said flow reactor. Additionally or alternatively, a laminar injector comprising a temperature-controlled flow straightener upstream of a flow reactor of an apparatus for producing carbon-based HARMSs may enable producing HARMS networks with a pre-defined optical transmittance and reduced sheet resistances.

Throughout this disclosure, a “flow straightener” or “honeycomb” may refer to a device or structure suitable for or configured to reduce, minimize, or remove swirl from a flow of one or more fluids and/or one or more aerosols. Additionally or alternatively a “flow straightener” or “honeycomb” may refer to a device suitable for or configured to reduce, minimize, or remove non-symmetry of such flow.

Further, a flow straightener being arranged “upstream of” a flow reactor may refer to said flow reactor comprising an upstream end and said flow straightener being arranged towards a countercurrent direction from said upstream end. Additionally or alternatively, a flow straightener being arranged upstream of a flow reactor may refer to said flow straightener being configured to discharge a catalyst particle precursor towards an injection direction and said flow reactor comprising an upstream end towards said injection direction from said flow straightener. Additionally or alternatively, a flow straightener being arranged upstream of a flow reactor may refer to said flow straightener being arranged outside of said flow reactor.

In this specification, a device or structure of an apparatus or part thereof being “temperature-controlled” may refer to temperature of said device or structure being maintained within a pre-defined temperature range during operation of said apparatus. Typically, temperatures within such pre-defined temperature range may be distinct from an ambient temperature at the location of said an apparatus and/or part thereof. Generally, a temperature-controlled device or structure of an apparatus or part thereof may or may not be thermally coupled to one or more heating elements for heating said temperature-controlled device or structure.

The apparatus 1000 of the embodiment of FIGS. 1 and 2 may be implemented as a continuous-flow apparatus. In other embodiments, an apparatus for producing catalyst particles may or may not be implemented as a continuous-flow apparatus. For example, in some embodiments, an apparatus for producing catalyst particles may be implemented as a batch apparatus.

In the embodiment of FIGS. 1 and 2, the flow reactor 1100 has an upstream end 1101, and the laminar injector 1200 is configured to introduce a catalyst particle precursor 1201 into the flow reactor 1100 such that a Re less than or equal to 2300 is maintained at the upstream end 1101. In other embodiments, a laminar injector may or may not be configured in such manner. For example, in some embodiments, a laminar injector may be configured to maintain a Re less than or equal to 2300, or less than or equal to 2100, or less than or equal to 2000 at an upstream end of a flow reactor.

The catalyst particle precursor 1201 of the embodiment of FIGS. 1 and 2 may be Fe(C₅H₂)2. In other embodiments, any suitable catalyst particle precursor (s) may be used.

In the embodiment of FIGS. 1 and 2, the flow reactor 1100 has a tubular shape. In particular, the flow reactor 1100 comprises a right circular cylindrical first section 1103 and a tapered second section 1104 extending from the first section 1103. Generally, a flow reactor having a tubular shape may provide improved control of the flow characteristics of a catalyst particle precursor in said flow reactor. In other embodiments, a flow reactor may have any suitable shape, for example, a tubular shape.

Throughout this disclosure, the term “tubular” is to be interpreted broadly. As such, the term tubular may refer to any elongate and hollow shape, which may have any suitable cross-sectional shape. An element having a tubular shape may or may not have a circular, substantially circular, elliptical, or polygonal cross-sectional shape. Additionally or alternatively, a tubular element may or may not be at least partly tapered, cylindrical, and/or curvilinear.

The flow reactor 1100 of the embodiment of FIGS. 1 and 2 comprises fused quartz. In other embodiments, flow reactor may comprise, consist substantially of, or consist of any suitable substances, for example, fused silica or quartz.

In the embodiment of FIGS. 1 and 2, the flow straightener 1210 comprises a flow straightener body 1211 defining a plurality of flow channels 1212 extending parallel to one another. Generally, a flow straightener comprising a flow straightener body defining a plurality of flow channels extending parallel to one another may facilitate maintaining a laminar flow profile at an upstream end of said flow reactor. Additionally or alternatively, a flow straightener comprising a flow straightener body defining a plurality of flow channels may facilitate passing heat from at least one heating element via said flow straightener evenly into a catalyst particle precursor introduced into a flow reactor by a laminar injector, which may, in turn, enable formation of catalyst particles with a narrower size distribution. In other embodiments, a flow straightener may be implemented in any suitable manner. For example, in some embodiments, a flow straightener may comprise a flow straightener body defining a plurality of flow channels extending parallel to one another.

The flow straightener body 1211 of the embodiment of FIGS. 1 and 2 comprises stainless steel. Generally, a flow straightener body being formed of a material with a higher thermal conductivity may further facilitate distributing heat evenly into a catalyst particle precursor introduced into a flow reactor by a laminar injector. In other embodiments, a flow straightener body may comprise, consist substantially of, or consist of any suitable materials, for example, metal(s), such as stainless steel and/or titanium.

In the embodiment of FIGS. 1 and 2, the plurality of flow channels 1212 are configured to guide the catalyst particle precursor 1201 towards an injection direction 1213, and the flow straightener body 1211 has a thickness (h_{fs}), measured along the injection direction 1213, of approximately 20 centimeters (cm). In other embodiments, a flow straightener body may have any suitable thickness, for example, a thickness greater than or equal to 2 cm, or to 5 cm, or to 10 cm and/or less than or equal to 100 cm, or to 50 cm, or to 30 cm.

In the embodiment of FIGS. 1 and 2, the laminar injector 1200 comprises at least one heating element 1220 for heating the flow straightener 1210. In particular, the at least one heating element 1220 of the embodiment of FIGS. 1 and 2 comprises an electric lateral heating element 1221 and an electric internal heating element 1222. Generally, a laminar injector comprising at least one heating element for heating the flow straightener may facilitate maintaining temperature of a flow straightener above an ambient temperature.

In other embodiments, a laminar injector may or may not comprise at least one heating element, e.g., a lateral heating element, such as a band heater, and/or an internal heating element, for heating a flow straightener, wherein one or more of said at least one heating element may be electric heating elements. In some embodiments, a laminar injector may comprise a radiative heater, e.g., a laser source, and/or an induction heater in addition or as an alternative to electric heating elements.

In the embodiment of FIGS. 1 and 2, the lateral heating element 1221 is specifically implemented as a band heater surrounding the flow straightener 1210, and the internal heating element 1222 is arranged within the flow straightener body 1211.

In other embodiments, wherein at least one heating element comprises a lateral heating element and/or an internal heating element, said lateral heating element may or may not surround a flow straightener and/or said internal heating element may be arranged at least partly within a flow straightener body. For example, in some embodiments, a lateral heating element may extend only partially around a flow straightener and at least one heating element may optionally comprise two or more such lateral heating elements.

The laminar injector 1200 of the embodiment of FIGS. 1 and 2 comprises a temperature sensor 1230 for measuring a temperature (T_{fs}) of the flow straightener 1210, and the apparatus 1000 comprises an injector temperature control unit 1300 operatively coupled with the temperature sensor 1230 and each of the lateral heating element 1221 and the electric internal heating element 1222 for maintaining a T_{fs} of approximately 275° C. Generally, maintaining a temperature of a flow straightener of a laminar injector of an apparatus for producing catalyst particles within a suitable temperature range may promote homogeneous nucleation of catalyst particles in a flow reactor of said apparatus.

In other embodiments, wherein a laminar injector of an apparatus for producing catalyst particles comprises a temperature sensor for measuring a temperature of a flow straightener, said apparatus may or may not comprise an injector temperature control unit operatively coupled with said temperature sensor and at least one heating element for maintaining said temperature in any suitable temperature range, for example, in a range from 100° C. to 700° C., or from 200° C. to 600° C., or from 250° C. to 400° C.

In this specification, a “control unit” may refer to a device, e.g., an electronic device, having at least one specified function related to determining and/or influencing an operational condition, status, or parameter related to another device, unit, or element. A control unit may or may not form a part of a multifunctional control system.

Further, a control unit being “operatively coupled” with a device, unit, or element may refer to the control unit having at least one specified function related to determining and/or influencing an operational condition, status, or parameter related to said device, unit, or element.

A control unit being “configured to” perform a process may refer to capability of and suitability of said control unit for such process. This may be achieved in various ways. For example, a control unit may comprise at least one processor and at least one memory coupled to the at least one processor, the memory storing program code instructions which, when executed on said at least one processor, cause the processor to perform the process (es) at issue. Additionally or alternatively, any functionally described features of a control unit may be performed, at least in part, by one or more hardware logic components. For example, and without limitation, illustrative types of suitable hardware logic components include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like. A control unit may generally be operated in accordance with any appropriate principles and by means of any appropriate circuitry and/or signals known in the art.

In the embodiment of FIGS. 1 and 2, the laminar injector 1200 comprises at least one gas inlet 1240, and the apparatus 1000 comprises an injector flow control unit 1400 configured to control volumetric flow rate through the at least one gas inlet 1240 such that residence time (t_{cat}) of the catalyst particle precursor 1201 in the flow straightener 1210 is approximately 1620 milliseconds (ms). Generally, a higher residence time of a catalyst particle precursor in a temperature-controlled flow straightener may reduce temperature variations in a catalyst particle precursor introduced into a flow reactor, whereas a lower residence time may reduce thermal decomposition of said catalyst particle precursor in said flow straightener.

In other embodiments, wherein a laminar injector of an apparatus for producing catalyst particles comprises at least one gas inlet, said apparatus may or may not comprise an injector flow control unit configured to control volumetric flow rate through said at least one gas inlet such that any suitable residence time of a catalyst particle precursor in a flow straightener is maintained. For example, in some such embodiments, residence time of said catalyst particle precursor in said flow straightener may be greater than or equal to 150 ms, or to 400 ms, or to 800 ms, and/or less than or equal to 8500 ms, or to 4000 ms, or to 2500 ms.

The apparatus 1000 of the embodiment of FIGS. 1 and 2 may be implemented as an apparatus for producing carbon-based HARMSs. In particular, the apparatus 1000 of the embodiment of FIGS. 1 and 2 may comprise means for introducing a carbon source 1202 into the flow reactor 1100. In other embodiments, wherein an apparatus for producing catalyst particles is implemented as an apparatus for producing carbon-based HARMSs, said apparatus may or may not comprise means for introducing a carbon source into a flow reactor into which a catalyst particle precursor is introduced. For example, in some embodiments, an apparatus for producing carbon-based HARMSs may comprise a first flow reactor for producing catalyst particles and an additional flow reactor for producing carbon-based HARMSs arranged downstream of the first flow reactor and configured to receive catalyst particles from said first flow reactor.

The carbon source 1202 of the embodiment of FIGS. 1 and 2 may consist substantially of carbon monoxide (CO). In other embodiments, a carbon source may comprise, consist substantially of, or consist of any suitable chemical compounds (s), such as CO and/or one or more hydrocarbons, for example, one or more aliphatic hydrocarbons, e.g., methane (CH₄), ethene (C₂H₄), and/or ethyne (C₂H₂); one or more aromatic hydrocarbons, e.g., benzene (C₆H₆), toluene (C₆H₅CH₃), dimethylbenzenes (C₆H₄(CH₃)₂), and/or trimethylbenzenes (C₆H₃(CH₃)₃); one or more alcohols, e.g., methanol (CH₃OH), ethanol (C₂H₅OH), and/or octanol (C₈H₁₇OH).

In the embodiment of FIGS. 1 and 2, the laminar injector 1200 of the embodiment of FIGS. 1 and 2 is configured to introduce the carbon source 1202 into the flow reactor 1100. In other embodiments, wherein an apparatus comprises means for introducing a carbon source into a flow reactor into which a catalyst particle precursor is introduced, a laminar injector may or may not be configured to introduce said carbon source into said flow reactor. In some embodiments, an apparatus for producing catalyst particles may comprise, as an alternative to or in addition to a laminar injector, a carbon source inlet separate from said laminar injector for feeding a carbon source into a flow reactor.

In order to mix the catalyst particle precursor 1201 and the carbon source 1202 prior to injection into the flow reactor 1100, the laminar injector 1200 comprises a mixing chamber 1250 upstream of the flow straightener 1210 as well as a pre-mixing chamber 1260 upstream of the mixing chamber 1250. Generally, a laminar injector comprising both a mixing chamber upstream of a flow straightener and a pre-mixing chamber upstream of said mixing chamber may enhance mixing of a catalyst particle precursor and a carbon source, which may, in turn, promote increase homogeneity of carbon-based HARMSs produced by an apparatus comprising such laminar injector.

In other embodiments, wherein a laminar injector is configured to introduce a catalyst particle precursor and a carbon source into a flow reactor, said laminar injector may or may not comprise a mixing chamber upstream of a flow straightener and a pre-mixing chamber upstream of said mixing chamber for mixing said catalyst particle precursor and said carbon source. For example, in some such embodiments, a laminar injector may comprise a mixing chamber upstream of a flow straightener in the absence of a pre-mixing chamber.

In the embodiment of FIGS. 1 and 2, the apparatus 1000 comprises a precursor conduit 1510 for feeding the catalyst particle precursor 1201 into the laminar injector 1200. The precursor conduit 1510 comprises a precursor conduit temperature sensor 1511 for measuring the temperature (T_{pc}) of the precursor conduit 1510 and a precursor conduit heating element 1512 for heating the precursor conduit 1510. The apparatus 1000 further comprises a conduit temperature control unit 1600 operatively coupled with the precursor conduit temperature sensor 1511 and the precursor conduit heating element 1512 for maintaining a T_{pc} of approximately 50° C. Generally, maintaining a temperature of a precursor conduit at a suitable pre-defined temperature may further reduce temperature variations in a catalyst particle precursor introduced into the flow reactor.

In other embodiments, wherein an apparatus for producing catalyst particles comprises a precursor conduit for feeding a catalyst particle precursor into a laminar injector, said precursor conduit may or may not comprise a precursor conduit temperature sensor for measuring a temperature of said precursor conduit and a precursor conduit heating element for heating the precursor conduit, and said apparatus may or may not further comprise a conduit temperature control unit operatively coupled with said precursor conduit temperature sensor and said precursor conduit heating element for maintaining said temperature in any suitable temperature range, for example, in a range from 30° C. to 200° C., or from 50° C. to 190° C., or from 100° C. to 180° C. For example, in some embodiments, precursor conduit heating elements with constant heating power per unit length of conduit may be used such that specific conduit temperature control units may be omitted.

The apparatus 1000 of the embodiment of FIGS. 1 and 2 further comprises a carbon source conduit 1520 for feeding the carbon source 1202 into the laminar injector 1200, and the carbon source conduit 1520 comprises a carbon source conduit temperature sensor 1521 for measuring a temperature (T_{cc}) of the carbon source conduit 1520 and a carbon source conduit heating element 1522 for heating the carbon source conduit 1520. The conduit temperature control unit 1600 is operatively coupled with the carbon source conduit temperature sensor 1521 and the carbon source conduit heating element 1522 for maintaining a Tₑc of approximately 50° C.

In other embodiments, wherein apparatus for producing catalyst particles comprises a carbon source conduit for feeding a carbon source into a laminar injector, said carbon source conduit may or may not comprise a carbon source conduit temperature sensor for measuring a temperature of the carbon source conduit and a carbon source conduit heating element for heating said carbon source conduit, and a conduit temperature control unit may or may not be operatively coupled with said carbon source conduit temperature sensor and said carbon source conduit heating element for maintaining said temperature in any suitable temperature range, for example, in a range from 30° C. to 200° C., or from 50° C. to 190° C., or from 100° C. to 180° C.

Although not explicitly shown in FIG. 1, a catalyst particle precursor and/or a carbon source may generally be introduced into a flow reactor using one or more carrier gases, such as argon (Ar), helium (He), nitrogen (N₂), carbon monoxide (CO), and/or hydrogen (H₂). For example, in the embodiment of FIGS. 1 and 2, H₂ may be used as a carrier gas.

In the embodiment of FIGS. 1 and 2, the apparatus 1000 comprises a tube furnace 1700 for holding the flow reactor 1100 such that an upstream portion 1102 of the flow reactor 1100 extends out of the tube furnace 1700 as well as a ventilated collar 1800 configured to surround the upstream portion 1102 for adjusting the temperature (Tᵤₚ) of the upstream portion 1102 during operation of the apparatus 1000. Generally, an apparatus for producing catalyst particles comprising such ventilated collar may enable optimizing a temperature profile in said flow reactor in a robust and efficient manner.

In other embodiments, wherein a flow reactor of an apparatus for producing catalyst particles has an upstream portion and said apparatus comprises a tube furnace for holding said flow reactor such that said upstream portion extends out of said tube furnace, said apparatus may or may not comprise a ventilated collar configured to surround at least part of said upstream portion for adjusting a temperature of said upstream portion during operation of said apparatus.

The ventilated collar 1800 of the embodiment of FIGS. 1 and 2 is configured to passively cool the upstream portion 1102 by subjecting the upstream portion 1102 to ambient air. In other embodiments, a ventilated collar may or may not be configured to passively cool an upstream portion by subjecting said upstream portion to ambient air. For example, in some embodiments, an actively ventilated collar may be used and/or an upstream portion may be subjected to one or more fluids other than air, e.g., nitrogen, argon, and/or water, for cooling said upstream portion.

The tube furnace 1700 of the embodiment of FIGS. 1 and 2 is configured to heat the flow reactor 1100 such that a highest temperature in the flow reactor 1100 is approximately 1100° C. In other embodiments, a tube furnace may be configured to heat a flow reactor to any suitable highest temperature, for example, a highest temperature greater than or equal to 700° C. or to 800° C. and/or less than or equal to 1300° C. or to 1200° C.

In the embodiment of FIGS. 1 and 2, the tube furnace 1700 is configured to hold the flow reactor 1100 upright. In other embodiments, a tube furnace of an apparatus for producing catalyst particles may be configured to hold a flow reactor in any suitable orientation with respect to gravity at the location of said apparatus, for example, upright, e.g., (substantially) vertically, or laterally, e.g., (substantially) horizontally.

It is to be understood that the embodiments of the first aspect described above may be used in combination with each other. Several of the embodiments may be combined together to form a further embodiment.

Above, mainly structural features of apparatuses for producing catalyst particles and parts thereof are discussed. In the following, more emphasis will lie on features related to methods for producing catalyst particles. What is said above about the ways of implementation, definitions, details, and advantages related to the apparatuses apply, mutatis mutandis, to the methods discussed below. The same applies vice versa.

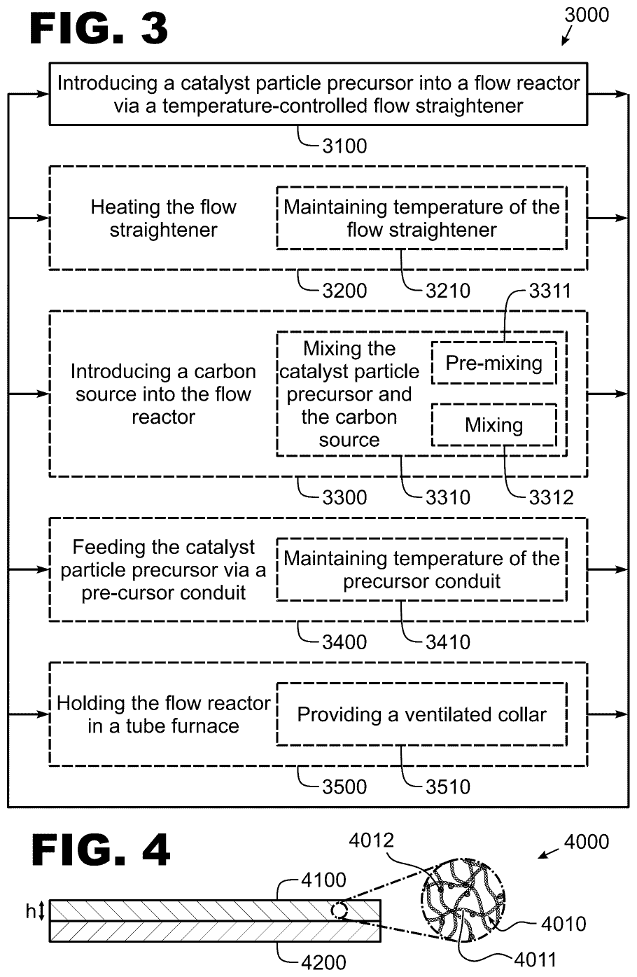

FIG. 3 illustrates a method 3000 for producing catalyst particles according to an embodiment. In other embodiments, a method for producing catalyst particles may be identical, similar, or different to the method 3000 of the embodiment of FIG. 3. In general, a method for producing catalyst particles may comprise any number of additional processes and/or steps that are not disclosed herein in connection to the method 3000 of the embodiment of FIG. 3.

The method 3000 of the embodiment of FIG. 3 may be implemented specifically as a continuous-flow method. In other embodiments, a method for producing catalyst particles may or may not be implemented as a continuous-flow method. For example, in some embodiments, a method for producing catalyst particles may be implemented as a batch method.

In this specification, a “process” may refer to a series of one or more steps, leading to an end result. As such, a process may be a single-step or a multi-step process. Additionally, a process may be divisible to a plurality of sub-processes, wherein individual sub-processes of such plurality of sub-processes may or may not share common steps. Herein, a “step” may refer to a measure taken in order to achieve a pre-defined result.

In the embodiment of FIG. 3, the method 3000 comprises introducing a catalyst particle precursor into a flow reactor via a temperature-controlled flow straightener 3100 arranged upstream of the flow reactor.

As indicated in FIG. 3 using dashed lines, the method 3000 of the embodiment of FIG. 3 may optionally further comprise heating the flow straightener 3200. The process of heating the flow straightener 3200 of the embodiment of FIG. 3 may comprise maintaining temperature of the flow straightener 3210 at approximately 275° C. In other embodiments, a process of heating the flow straightener may comprise maintaining temperature of the flow straightener 3210 at any suitable temperature(s), for example, in a range from 100° C. to 700° C., or from 200° C. to 600° C., or from 250° C. to 400° C.

In the embodiment of FIG. 3, residence time of the catalyst particle precursor in the flow straightener may be approximately 1620 milliseconds (ms). In other embodiments, any suitable residence time(s), for example, a residence time greater than or equal to 150 ms, or to 400 ms, or to 800 ms, and/or less than or equal to 8500 ms, or to 4000 ms, or to 2500 ms may be used.

The method 3000 of the embodiment of FIG. 3 may optionally be implemented as a method for producing carbon-based HARMSs. In other embodiments, a method for producing catalyst particles may or may not be implemented as a method for producing carbon-based HARMSs.

As indicated in FIG. 3 using dashed lines, the method 3000 of the embodiment of FIG. 3 may optionally further comprise a process of introducing a carbon source into the flow reactor 3300. In other embodiments, a method for producing catalyst particles may or may not comprise a process of introducing a carbon source into the flow reactor.

The process of introducing a carbon source into the flow reactor 3300 of the embodiment of FIG. 3 comprises mixing the catalyst particle precursor and the carbon source 3310 upstream of the flow straightener. In other embodiments, wherein a method for producing catalyst particles comprises introducing a carbon source into the flow reactor, said process of introducing a carbon source into the flow reactor may or may not comprise mixing the catalyst particle precursor and the carbon source upstream of the flow straightener.

As indicated in FIG. 3 using dashed lines, the process of mixing the catalyst particle precursor and the carbon source 3310 of the embodiment of FIG. 3 may optionally comprise a step of pre-mixing 3311 the catalyst particle precursor and the carbon source in a pre-mixing chamber as well as a step of mixing 3312 the catalyst particle precursor and the carbon source in a mixing chamber arranged downstream from the pre-mixing chamber.

In other embodiments, wherein a method for producing catalyst particles comprises introducing a carbon source into the flow reactor and the process of introducing a carbon source into the flow reactor comprises mixing the catalyst particle precursor and the carbon source upstream of the flow straightener, the process of mixing the catalyst particle precursor and the carbon source may or may not comprise steps of pre-mixing and mixing the catalyst particle precursor and the carbon source in a pre-mixing chamber and in a mixing chamber arranged downstream from the pre-mixing chamber, respectively.

As indicated in FIG. 3 using dashed lines, the method 3000 of the embodiment of FIG. 3 may optionally further comprise feeding the catalyst particle precursor via a precursor conduit 3400 into the laminar injector, the process of feeding the catalyst particle precursor via a precursor conduit 3400 comprising maintaining temperature of the precursor conduit 3410 at approximately 50° C. In other embodiments, wherein a method for producing catalyst particles comprises feeding the catalyst particle precursor via a precursor conduit into the laminar injector, the process of feeding the catalyst particle precursor via a precursor conduit may or may not comprise maintaining temperature of the precursor conduit at any suitable pre-defined temperature, for example, in a range from 30° C. to 200° C., or from 50° C. to 190° C., or from 100° C. to 180° C.

As indicated in FIG. 3 using dashed lines, the method 3000 of the embodiment of FIG. 3 may optionally further comprise holding the flow reactor in a tube furnace 3500 such that an upstream portion of the flow reactor extends out of the tube furnace. In other embodiments, a method for producing catalyst particles may or may not comprise holding the flow reactor in a tube furnace in such manner.

As indicated in FIG. 3 using dashed lines, the process of holding the flow reactor in a tube furnace 3500 of the embodiment of FIG. 3 may optionally comprise providing a ventilated collar 3510 surrounding the upstream portion. In other embodiments, wherein a method for producing catalyst particles comprises holding the flow reactor in a tube furnace such that an upstream portion of the flow reactor extends out of the tube furnace, the process of holding the flow reactor in a tube furnace may or may not comprise providing a ventilated collar surrounding the upstream portion.

It is to be understood that the embodiments of the second aspect described above may be used in combination with each other. Several of the embodiments may be combined together to form a further embodiment.

FIG. 4 depicts a HARMS network 4000 consisting substantially of HARMSs 4010 obtainable by an apparatus for producing carbon-based HARMSs in accordance with the first aspect and a method for producing carbon-based HARMSs in accordance with the second aspect. In other embodiments, a HARMS network may comprise, consist substantially of, or consist of HARMSs obtainable by an apparatus for producing carbon-based HARMSs in accordance with the first aspect and a method for producing carbon-based HARMSs in accordance with the second aspect. For example, in some embodiments, a HARMS network may comprise HARMSs obtainable by an apparatus for producing carbon-based HARMSs in accordance with the first aspect and a method for producing carbon-based HARMSs in accordance with the second aspect and one or more types of non-carbon-based HARMSs, such as metal nanowires, e.g., silver nanowires.

The HARMS network 4000 of the embodiment of FIG. 4 is arranged as a film 4100 extending on a substrate 4200. In other embodiments, a HARMS network may be arranged in any suitable form, for example, as a film extending on a substrate or as a free-standing film.

The film 4100 of the embodiment of FIG. 4 may have a thickness (h_{f}) of approximately 60 nm. In other embodiments, wherein a HARMS network is arranged as a film, said film may have any suitable thickness, for example, a thickness greater than or equal to 1 nm, or to 10 nm, or to 50 nm, or to 100 nm, and/or less than or equal to 1000 nm, or to 800 nm, or to 500 nm.

In the embodiment of FIG. 4, the HARMSs 4010 comprise carbon nanotube backbones 4011 covalently bonded to carbon-based fullerene-like protrusions 4012 extending from the carbon nanotube backbones 4011. In other embodiments, HARMSs obtainable by an apparatus for producing carbon-based HARMSs in accordance with the first aspect and a method for producing carbon-based HARMSs in accordance with the second aspect may or may not comprise single-walled and/or multi-walled carbon nanotube backbones covalently bonded to carbon-based fullerene-like protrusions extending from said carbon nanotube backbones.

It is obvious to a person skilled in the art that with the advancement of technology, the basic idea of the invention may be implemented in various ways. The invention and its embodiments are thus not limited to the examples described above, instead they may vary within the scope of the claims.

It will be understood that any benefits and advantages described above may relate to one embodiment or may relate to several embodiments. The embodiments are not limited to those that solve any or all of the stated problems or those that have any or all of the stated benefits and advantages.

The term “comprising” is used in this specification to mean including the feature(s) or act(s) followed thereafter, without excluding the presence of one or more additional features or acts. It will further be understood that reference to ‘an’ item refers to one or more of those items.

ABBREVIATIONS AND REFERENCE SIGNS

| HARMS | high-aspect-ratio molecular structure |
|---|---|
| FCCVD | floating-catalyst chemical vapor deposition |
| Re | Reynolds number |
| T_{fs} | temperature of the flow straightener |
| T_{pc} | temperature of the precursor conduit |
| T_{cc} | temperature of the carbon source conduit |
| Tᵤₚ | temperature of the upstream portion |
| t_{cat} | residence time |
| h_{f} | thickness of the film |
| h_{fs} | thickness of the flow straightener body |
| 1000 | apparatus |
| 1100 | flow reactor |
| 1101 | upstream end |
| 1102 | upstream portion |
| 1103 | first section |
| 1104 | second section |
| 1200 | laminar injector |
| 1201 | catalyst particle precursor |
| 1202 | carbon source |
| 1210 | flow straightener |
| 1211 | flow straightener body |
| 1212 | plurality of flow channels |
| 1213 | injection direction |
| 1220 | at least one heating element |
| 1221 | lateral heating element |
| 1222 | internal heating element |
| 1230 | temperature sensor |
| 1240 | at least one gas inlet |
| 1250 | mixing chamber |
| 1260 | pre-mixing chamber |
| 1300 | injector temperature control unit |
| 1400 | injector flow control unit |
| 1510 | precursor conduit |
| 1511 | precursor conduit temperature sensor |
| 1512 | precursor conduit heating element |
| 1520 | carbon source conduit |
| 1521 | carbon source conduit temperature sensor |
| 1522 | carbon source conduit heating element |
| 1600 | conduit temperature control unit |
| 1700 | tube furnace |
| 1800 | ventilated collar |
| 3000 | method |
| 3100 | introducing a catalyst particle precursor |
| | into a flow reactor via a temperature- |
| | controlled flow straightener |
| 3200 | heating the flow straightener |
| 3210 | maintaining temperature of the flow straightener |
| 3300 | introducing a carbon source into the flow reactor |
| 3310 | mixing the catalyst particle precursor and the carbon source |
| 3311 | pre-mixing |
| 3312 | mixing |
| 3400 | feeding the catalyst particle precursor via a precursor conduit |
| 3410 | maintaining temperature of the precursor conduit |
| 3500 | holding the flow reactor in a tube furnace |
| 3510 | providing a ventilated collar |
| 4000 | HARMS network |
| 4010 | HARMSs |
| 4011 | carbon nanotube backbone |
| 4012 | protrusion |
| 4100 | film |
| 4200 | substrate |

1. An apparatus for producing catalyst particles, the apparatus comprising:
a flow reactor and
a laminar injector configured to introduce a catalyst particle precursor into the flow reactor,
wherein the laminar injector comprises a temperature-controlled flow straightener arranged upstream of the flow reactor;
characterized in that the laminar injector comprises at least one heating element for heating the flow straightener.

2. An apparatus according to claim 1, wherein the flow reactor has a tubular shape.

3. An apparatus according to claim 1, wherein the flow straightener comprises a flow straightener body defining a plurality of flow channels extending parallel to one another.

4. An apparatus according to claim 1, wherein the at least one heating element comprises a lateral heating element and/or an internal heating element for heating the flow straightener.

5. An apparatus according to claim 4, wherein the laminar injector comprises a temperature sensor for measuring a temperature, T_{fs}, of the flow straightener, and the apparatus comprises an injector temperature control unit operatively coupled with the temperature sensor and the at least one heating element for maintaining the temperature, T_{fs}, of the flow straightener in a range from 100° C. to 700° C., or from 200° C. to 600° C., or from 250° C. to 400° C.

6. An apparatus according to claim 1, wherein the laminar injector comprises at least one gas inlet, and the apparatus comprises an injector flow control unit configured to control volumetric flow rate through the at least one gas inlet such that a residence time, t_{cat}, of the catalyst particle precursor in the flow straightener is greater than or equal to 150 ms, or to 400 ms, or to 800 ms, and/or less than or equal to 8500 ms, or to 4000 ms, or to 2500 ms.

7. An apparatus according to claim 1, wherein the laminar injector is configured to introduce a carbon source into the flow reactor, and the laminar injector comprises a mixing chamber upstream of the flow straightener and a pre-mixing chamber upstream of the mixing chamber for mixing the catalyst particle precursor and the carbon source.

8. An apparatus according to claim 1, wherein the apparatus comprises a precursor conduit for feeding the catalyst particle precursor into the laminar injector; the precursor conduit comprises a precursor conduit temperature sensor for measuring a temperature, T_{pc}, of the precursor conduit and a precursor conduit heating element for heating the precursor conduit; and the apparatus further comprises a conduit temperature control unit operatively coupled with the precursor conduit temperature sensor and the precursor conduit heating element for maintaining the temperature, T_{pc}, of the precursor conduit in a range from 30° C. to 200° C., or from 50° C. to 190° C., or from 100° C. to 180° C.

9. An apparatus according to claim 1, wherein the flow reactor has an upstream portion, and the apparatus comprises a tube furnace for holding the flow reactor such that the upstream portion extends out of the tube furnace and a ventilated collar configured to surround at least part of the upstream portion for adjusting a temperature, Tᵤₚ, of the upstream portion during operation of the apparatus.

10. A method for producing catalyst particles, the method comprising introducing a catalyst particle precursor into a flow reactor via a temperature-controlled flow straightener arranged upstream of the flow reactor and heating the flow straightener with a laminar injector configured to introduce the catalyst particle precursor into the flow reactor.

11. A method according to claim 10, wherein the process of comprises heating the flow straightener comprises maintaining temperature of the flow straightener in a range from 100° C. to 700° C., or from 200° C. to 600° C., or from 250° C. to 400° C.

12. A method according to claim 10, wherein residence time of the catalyst particle precursor in the flow straightener is greater than or equal to 150 ms, or to 400 ms, or to 800 ms, and/or less than or equal to 8500 ms, or to 4000 ms, or to 2500 ms.

13. A method according to claim 10, wherein the method comprises introducing a carbon source into the flow reactor, the process of introducing a carbon source into the flow reactor comprises mixing the catalyst particle precursor and the carbon source upstream of the flow straightener, and the process of mixing the catalyst particle precursor and the carbon source comprises steps of pre-mixing and mixing the catalyst particle precursor and the carbon source in a pre-mixing chamber and in a mixing chamber arranged downstream from the pre-mixing chamber, respectively.

14. A method according to claim 10, wherein the method comprises feeding the catalyst particle precursor via a precursor conduit into the laminar injector, and the process of feeding the catalyst particle precursor via a precursor conduit comprises maintaining temperature of the precursor conduit in a range from 30° C. to 200° C., or from 50° C. to 190° C., or from 100° C. to 180° C.

15. A method according to claim 10, wherein the method comprises holding the flow reactor in a tube furnace such that an upstream portion of the flow reactor extends out of the tube furnace, and the process of holding the flow reactor in a tube furnace comprises providing a ventilated collar surrounding the upstream portion.

16. A method according to claim 10, wherein the method is implemented as a method for producing carbon-based high-aspect-ratio molecular structures, HARMSs, such as carbon nanotubes, e.g., single-walled carbon nanotubes and/or multi-walled carbon nanotubes; carbon nanobuds; and/or graphene nanoribbons.

17. A HARMS network comprising carbon-based HARMSs obtainable by a method in accordance with claim 16.
